(19) United States
(12) Patent Application Publication
(10) Pub. No.: US 2006/0182018 A1
(43) Pub. Date: Aug. 17, 2006

(54) MULTIPLE ACCESS HIERARCHICAL CELLULAR NETWORK AND MULTIPLE ACCESS MOBILE COMMUNICATION TERMINAL

(76) Inventors: SAE-WOONG BAHK, Seoul (KR); YOUNG-JUNE CHOI, Seoul (KR); JUNG-HYON JUN, Seoul (KR)

Correspondence Address: IPLA P.A., 3580 WILSHIRE BLVD., 17TH FLOOR, LOS ANGELES, CA, 90010, US

(21) Appl. No.: 11/164,945

(22) Filed: Dec. 12, 2005

(30) Foreign Application Priority Data
Dec. 18, 2004 (KR) 10-2004-0108350

(51) Int. Cl. H04B 1/713; H04J 11/00

(52) U.S. Cl. 370/208; 375/132

(57) ABSTRACT

Disclosed herein are a multiple access hierarchical cellular network and a multiple access mobile communication terminal using the multiple access hierarchical cellular network. The multiple access hierarchical cellular network includes a macrocell that is served by Frequency Hopping-Orthogonal Frequency Division Multiple Access (FH-OFDMA), and microcells that are served by Orthogonal Frequency Division Multiple Access (OFDMA). The multiple access mobile communication terminal accesses a macrocell, which is served by FH-OFDMA, using FH-OFDMA when it moves at a speed higher than a predetermined speed, and a microcell, which is served by OFDMA, using OFDMA when it moves at a speed lower than the predetermined speed.

### BACKGROUND OF THE INVENTION

1. Field of the Invention

The present invention relates generally to a multiple access hierarchical cellular network and a multiple access mobile communication terminal using the multiple access hierarchical cellular network, and, more particularly, to a multiple access hierarchical cellular network in which a macrocell is served by Frequency Hopping-Orthogonal Frequency Division Multiple Access and microcells are served by Orthogonal Frequency Division Multiple Access, so that support is provided such that a single terminal can access a cell using multiple access, such as Frequency Hopping-Orthogonal Frequency Division Multiple Access and Orthogonal Frequency Division Multiple Access, and a multiple access mobile communication terminal that can use Orthogonal Frequency Division Multiple Access suitable for data communication during low-speed movement and enables coherent detection during high-speed movement, using the multiple access hierarchical cellular network.

2. Description of the Related Art

Recently, a third generation (3G) mobile communication network, which is represented by International Mobile Telecommunications IMT-2000, has been commercialized, and research into a fourth generation (4G) network is actively being carried out.

Although IMT-2000 attempted to enable the 3 GHz frequency band roaming between all countries in the world, such roaming became impossible because IMT-2000 was divided into a synchronous type and an asynchronous type. Furthermore, the provision of service has been postponed due to a variety of reasons, such as the excessive investment cost necessary for the development of systems. In particular, a 3G mobile communication network has the disadvantage of incurring high development cost due to a large number of protocols and the complicated structure of an access network.

A basic approach to the construction of a 4G mobile communication network resides in the simple design of the complicated structure of a 3G mobile communication network. The solution to the approach resides in the construction of an All-Internet Protocol (IP) network. That is, the All-IP network enables direct access to a backbone IP network without additional protocol transformation, and allows an existing IP protocol to be used in an access network.

In the 3G mobile communication network, a separate protocol layer is defined in an access network, so that the transformation of formats between protocols must be performed at the time of data exchange with a backbone network and other communication networks and, therefore, the 3G mobile communication network may be considered to be efficient.

The fundamental difference results from the fact that the existing cellular communication network is based on a circuit switching method while the 4G mobile communication network is based on a packet switching method.

The 4G mobile communication network is usually proposed from the point of view of the cooperation of various networks for ubiquitous networking. That is, the 3G mobile communication network may be proposed as an integrated model for the cases ranging from the basic cooperation of an existing cellular network and a wireless Local Area Network (LAN) to cooperation with a home network and a wireless Personal Area Network (PAN).

However, the conventional cellular network is based on a circuit switching method and has a low data rate, so that the construction of a new packet switched cellular network capable of high-speed data transmission is keenly desired. Systems currently developed by companies aim at constructing new cellular networks in consideration of high-speed data transmission.

The early stage mobile communication networks employ Frequency Division Multiple Access (FDMA) or Time Division Multiple Access (TDMA), whereas the multiple access of the 3G mobile communication network is based on Code Division Multiple Access (CDMA).

CDMA allows respective users to communicate with each other without interference in such a way as to assign different codes having high orthogonality to the respective users. When the codes are assigned in the above-described way, a user returns a code after continuously using the code, so that CDMA is appropriate for a voice communication network.

However, in the case of a data communication network, traffic may flood the network, so that the assignment of a code to each user may be waste of resources. Accordingly, in data-dedicated systems, such as CDMA2000 1× EV-DO, all of the users share a single code.

The 4G mobile communication network may employ multiple access schemes that are more suitable for data communication than a CDMA access scheme. Of the multiple access schemes, the one worth consideration is Orthogonal Frequency Division Multiple Access (OFDMA).

OFDMA is a combination of Orthogonal Frequency Division Multiplexing (OFDM) (OFDM is used to reduce Inter Symbol Interference (ISI) attributable to multi-fading in a wireless communication environment) and FDMA, and enables transmission in such a way as to simultaneously assign different subchannels to a plurality of users.

OFDMA has a greater granularity of resources because a resource can be finely divided and assigned along the time and frequency axes, and can support various data rates without performing power control because an adaptive modulation and coding technique can be easily applied.

However, a symbol is long, so that coherent detection cannot be achieved in the case where the speed of a user is high and, therefore, there is a problem with the application of OFDMA.

In consideration of the above-described problem, the Korean portable Internet standard adopting OFDMA is configured to support users who are moving at a speed up to 60 km per hour. In IEEE 802.16 standard, OFDM and OFDMA are employed. The original purpose of the employment of OFDM and OFDMA is to support fixed Wireless Metropolitan/Local Area Network (MAN/LAN). Slight mobility is provided by IEEE 802.16e standard.

In general, cells may be classified into macrocells, microcells, picocells and the like according to the service area. According to the purpose of the cell, cells are classified into the following types: macrocells having low population density, microcells corresponding to metropolitan areas, and picocells corresponding to the interiors of buildings.

Furthermore, a cell may be hierarchically constructed so that access to both a macrocell and a microcell can be enabled. In the paper by S. S. Rappaport and L. R. Hu, “Microcellular communication systems with hierarchical macrocell overlays: traffic performance models and analysis,” Proceedings of IEEE, vol. 82, no. 9, September 1994, pp. 1383-1397, such a hierarchical cell structure was proposed for the purpose of supporting a “Hot Spot”.

Meanwhile, in the paper by C. L. I, L. J. Greenstein and R. D. Gitlin, “A microcell/macrocell cellular architecture for low- and high-mobility wireless users”, IEEE Journal on Selected Areas in Communications, vol. 11, no. 6, pp. 885-891, August 1993, a model in which the mobility of a node was classified, a high-mobility node was served in a macrocell and a low-mobility node was served in a microcell was proposed.

In the article by X. Wu, B. Mukher, and D. Ghosal, “Hierarchical architectures in the third-generation cellular network”, IEEE Wireless Communications, vol. 11, no. 3, June 2004, the statement in which such a hierarchical cellular network structure must be used, with a high-mobility node and a low-mobility node being distinguished and served in a 3G mobile communication network, was made.

Since such classification of cells according to the speed can solve the problem of the frequent handoff of a high-mobility node, this is desirable in terms of a network. In particular, when mobile IP is applied, handoff based on the application of mobile IP causes considerable overhead, so that such a hierarchical cellular network structure can be an efficient solution.

However, notwithstanding that such a hierarchical cellular network structure is applicable, a problem still remains in that a user moving at a speed higher than 60 km per hour is disabled from achieving coherent detection in a portable Internet standard that adopts OFDMA.

### SUMMARY OF THE INVENTION

Accordingly, the present invention has been made keeping in mind the above problems occurring in the prior art, and an object of the present invention is to provide a multiple access hierarchical cellular network in which a macrocell is served by Frequency Hopping-Orthogonal Frequency Division Multiple Access (FH-OFDMA) and microcells are served by OFDMA, so that the multiple access of a single terminal, such as FH-OFDMA and OFDMA, to a cell can be supported.

Another object of the present invention is to provide a multiple access mobile communication terminal in which OFDMA suitable for data communication can be used during low-speed movement and coherent detection using FH-OFDMA is enabled during high-speed movement.

Still another object of the present invention is to provide a multiple access mobile communication terminal in which FH-OFDMA is used when voice communication is performed even during low-speed movement, so that coherent detection using FH-OFDMA is enabled when voice communication is performed.

In order to accomplish the above object, the present invention provides a multiple access hierarchical cellular network, including a macrocell that is served by FH-OFDMA; and microcells that are served by OFDMA.

Additionally, in order to accomplish the above object, the present invention provides a multiple access mobile communication terminal accessing a macrocell, which is served by FH-OFDMA, using FH-OFDMA when it moves at a speed higher than a predetermined speed, and a microcell, which is served by OFDMA, using OFDMA when it moves at a speed lower than the predetermined speed.

Additionally, in order to accomplish the above object, the present invention provides a multiple access mobile communication terminal accessing a macrocell, which is served by FH-OFDMA, using FH-OFDMA when it moves at a speed higher than a predetermined speed or voice traffic is used, and a microcell, which is served by OFDMA, using OFDMA when it moves at a speed lower than the predetermined speed and data traffic is used.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram of a multiple access hierarchical cellular network according to an embodiment of the present invention;

FIG. 2 is a block diagram of a multiple access mobile communication terminal using the multiple access hierarchical cellular network, according to the first embodiment of the present invention; and

FIG. 3 is a block diagram of a multiple access mobile communication terminal using the multiple access hierarchical cellular network, according to the second embodiment of the present invention.

### DESCRIPTION OF THE PREFERRED EMBODIMENTS

Preferred embodiments of the present invention are described in detail with reference to the accompanying drawings.

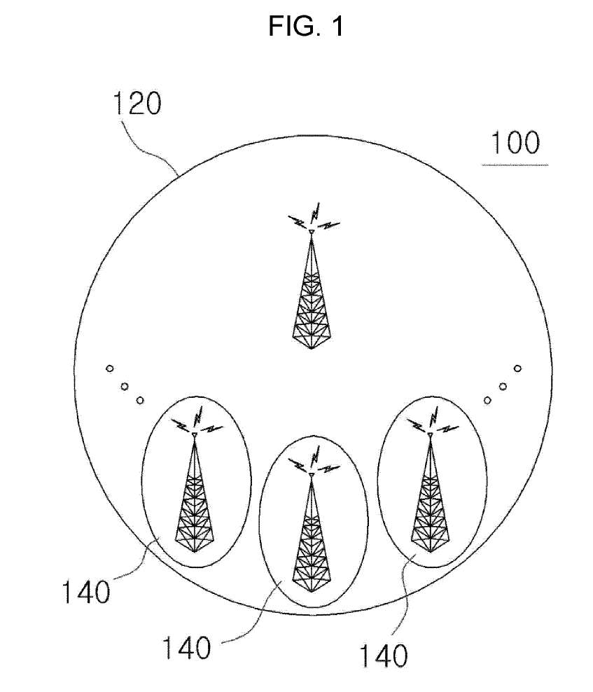

FIG. 1 is a schematic diagram of a multiple access hierarchical cellular network 100 according to an embodiment of the present invention.

Referring to FIG. 1, the service area of the multiple access hierarchical cellular network 100 according to the embodiment of the present invention is divided into a macrocell 120, and microcells 140 included in the coverage of the macrocell 120.

The macrocell 120 is served by Frequency Hopping-Orthogonal Frequency Division Multiple Access (FH-OFDMA), well known to the related field, while the microcells 140 are served by Orthogonal Frequency Division Multiple Access (OFDMA).

FH-OFDMA is a scheme in which Frequency Hopping (FH) has been applied to OFDMA. According to FH-OFDMA, a hopping is performed between narrowly divided frequency bands based on a predetermined pattern, so that the degradation of the state of a specific frequency channel can be easily overcome even though the state of the specific frequency channel is degraded, and it is easy to apply diversity. Accordingly, it is possible to provide service to users who are moving at a low speed.

That is, although FH-OFDMA cannot guarantee a high transmission rate, unlike OFDMA, and is difficult to use a channel state feedback-based adaptive modulation and coding technique, it can easily overcome interference caused by the user of a different cell and the change of the state of a channel caused by a fading state using a diversity effect if hopping codes based on different patterns are appropriately provided between cells.

A multiple access mobile communication terminal 200 according to a first embodiment of the present invention accesses a macrocell 120, which is served by FH-OFDMA, using FH-OFDMA in the case where it is moving at a speed higher than a predetermined speed, and accesses a microcell 140, which is served by OFDMA, using OFDMA in the case where it is moving at a speed lower than the predetermined speed.

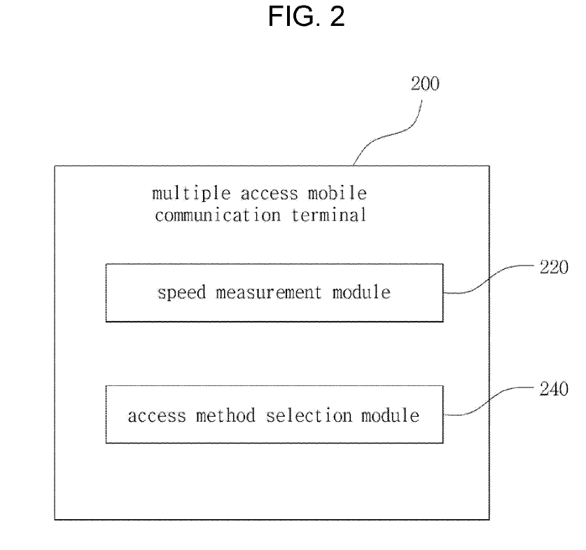

FIG. 2 is a block diagram of a multiple access mobile communication terminal 200 using the multiple access hierarchical cellular network 100, according to the first embodiment of the present invention.

Referring to FIG. 2, the multiple access mobile communication terminal 200 according to the first embodiment of the present invention includes a speed measurement module 220 and an access method selection module 240.

The speed measurement module 220 is a module for measuring the speed of the multiple access mobile communication terminal 200. For an example, a Global Positioning System (GPS) device may be used as the speed measurement module 220.

Furthermore, even in a 4G mobile communication system, as well as a 3G mobile communication system, there is no problem with the detection of information about the location of a mobile communication terminal, so that the speed measurement module 220 for detecting the speed of a mobile communication terminal can be sufficiently implemented using conventional technology.

The access method selection module 240 receives information about the speed of the terminal from the speed measurement module 220, and causes the terminal to access the macrocell 120, which is served by FH-OFDMA, using FH-OFDMA when the speed of the terminal is higher than a predetermined speed and to access a microcell 140, which is served by OFDMA, using OFDMA when the speed of the terminal is lower than the predetermined speed.

Meanwhile, it is preferable to use FH-OFDMA in the case of transmitting and receiving low bandwidth signals, such as voice signals, even in the case where the terminal is moving at a low speed.

Since FH-OFDMA facilitates the application of diversity and can guarantee a constant data rate, it is an effective communication method in the case where voice traffic is used. In particular, the microcell 140 that is served by OFDMA has a strong possibility of processing a large amount of traffic, so that the processing of voice traffic in the macrocell 120 helps to effectively control the load of a network.

A multiple access mobile communication terminal 200 according to a second embodiment of the present invention accesses a macrocell 120 that is served by FH-OFDMA, using FH-OFDMA in the case where it is moving at a speed higher than a predetermined speed or voice traffic is used, and accesses a microcell 140 that is served by OFDMA, using OFDMA in the case where it is moving at a speed lower than the predetermined speed and data traffic is used.

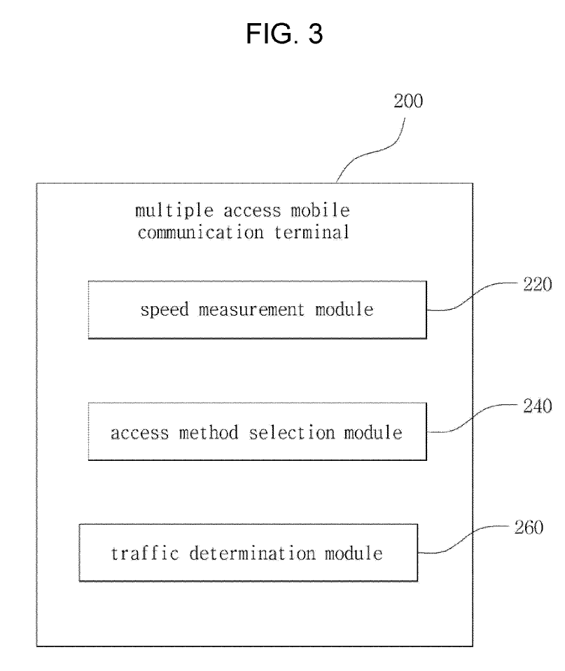

FIG. 3 is a block diagram of a multiple access mobile communication terminal 200 using the multiple access hierarchical cellular network 100, according to the second embodiment of the present invention.

Referring to FIG. 3, the multiple access mobile communication terminal 200 according to the second embodiment of the present invention includes a speed measurement module 220, an access method selection module 240 and a traffic determination module 260.

The speed measurement module 220 is the same as that of the first embodiment.

The traffic determination module 260 determines the type of traffic transmitted and received in the multiple access mobile communication terminal 200. That is, the traffic determination module 260 determines whether transmitted or received traffic is voice traffic or data traffic. Since the technology for determining the type of traffic is well known to those skilled in the art, a detailed description of the technology is omitted here.

The access method selection module 240 receives information about the speed of the terminal from the speed measurement module 220 and information about the type of traffic from the traffic determination module 260, and causes the terminal to access the macrocell 120 that is served by FH-OFDMA, using FH-OFDMA when the speed of the terminal is higher than a predetermined speed or voice traffic is used and to access a microcell 140 that is served by OFDMA, using OFDMA when the speed of the terminal is lower than the predetermined speed.

As described above, according to the multiple access hierarchical cellular network of the present invention, the macrocell is served by FH-OFDMA and the microcells are served by OFDMA, so that it is advantageous in that the multiple access of a single terminal, such as FH-OFDMA and OFDMA, to a cell can be supported.

Furthermore, according to the multiple access mobile communication terminal of the present invention, it is advantageous in that OFDMA, suitable for data communication, can be used during low-speed movement and coherent detection using FH-OFDMA is enabled during high-speed movement.

Furthermore, according to the multiple access mobile communication terminal of the present invention, it is advantageous in that FH-OFDMA is used when voice communication is performed even during low-speed movement, so that coherent detection using FH-OFDMA is enabled when voice communication is performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multiple access hierarchical cellular network, comprising:
a macrocell that is served by Frequency Hopping-Orthogonal Frequency Division Multiple Access (FH-OFDMA); and
microcells that are served by Orthogonal Frequency Division Multiple Access (OFDMA).

2. A multiple access mobile communication terminal accessing a macrocell, which is served by FH-OFDMA, using FH-OFDMA when it moves at a speed higher than a predetermined speed, and a microcell, which is served by OFDMA, using OFDMA when it moves at a speed lower than the predetermined speed.

3. A multiple access mobile communication terminal accessing a macrocell, which is served by FH-OFDMA, using FH-OFDMA when it moves at a speed higher than a predetermined speed or voice traffic is used, and a microcell, which is served by OFDMA, using OFDMA when it moves at a speed lower than the predetermined speed and data traffic is used.
